(19) United States
(12) Patent Application Publication
(10) Pub. No.: US 2006/0111154 A1
(43) Pub. Date: May 25, 2006

(54) Apparatus and method for a full-duplex speakerphone using a digital automobile radio and a cellular phone

(76) Inventor: Thanh T. Tran, Houston, TX (US)

Correspondence Address: TEXAS INSTRUMENTS INCORPORATED, P O BOX 655474, M/S 3999, DALLAS, TX, 75265, US

(21) Appl. No.: 10/995,753

(22) Filed: Nov. 23, 2004

(51) Int. Cl. H04M 1/00

(52) U.S. Cl. 455/569.2; 455/556.1

(57) ABSTRACT

An automobile digital radio and a cell phone are coupled to provide a hands-free full-duplex speakerphone for the vehicle operator. A digital signal processor and associated apparatus of the digital radio can be used to provide echo-cancellation. The system can be used for both full-duplex communication and for audio performance presentation. The programming capacity of the digital radio automatically inserts an appropriate pass-band algorithm to apply to each type of programming. In addition, dynamic band-pass switching, the digital signal processor detects and mutes the nearest speakers and to further reduce the unwanted sounds and, therefore, improves the full duplex speakerphone performance. The digital signal processor uses an automatic calibration method to determine the nearest speakers, for example playing and recording sounds on each individual speaker and comparing the sound pressure level (SPL) to figure out the closest speakers.

### BACKGROUND OF THE INVENTION

1. Field of the Invention

This invention relates generally to the receipt and transmission of audio signals in an automobile or other vehicle. In particular, using a cell phone and a digital radio, a full-duplex speakerphone system and system for playing to broadcast programming can be provided.

2. Background of the Invention

When driving in an automobile, the principal technique for communication has been the cell phone. With appropriate head set apparatus, the cell phone can provide a hands-free communication system. By applying the earphone portion of the headset to an amplifier, a speakerphone can be produced. However, the cell phone, even with the amplifiers, does not provide for a full-duplex speakerphone system.

A need has been felt for apparatus and an associated method having the feature of being able to provide a user in an automobile with full-duplex broadcast communication. It would a further feature of the apparatus and associated method to provide full-duplex communication using a commercially available component. It would be another feature of the present invention to use communication through a cell phone as the basis for speakerphone-full-duplex communication. It would be still another feature of the present invention to provide full-duplex speakerphone communication using a cell phone and a digital radio. It would be yet a further feature of the apparatus and associated method to provide for echo-cancellation in the speakerphone mode of operation. It would still be a further feature of apparatus and associated method to automatically detect the broadcast or speakerphone mode and determine the optimum audio band for that mode. For example, in broadcast mode, full audio spectrum is required and in speakerphone mode, only voice band is necessary.

### SUMMARY OF THE INVENTION

The aforementioned features are accomplished, according to the present invention, by coupling the microphone terminal and speaker terminal to a digital signal radio to prevent unwanted sounds from interfering with the voice communication. When the combination is to be used in a full duplex speakerphone mode of operation, the broadcast input to the digital signal radio is disabled. The signals from the cell phone, both the received broadcast signals and the signals transmitted from the cell phone, are applied to the digital radio and processed in accordance with selectable procedures. Because the sound from the speakerphone can be detected by the audio input of the cell phone, precautions must be taken to accommodate the audio feedback.

Other features and advantages of the present invention will be more clearly understood upon reading of the following description and the accompanying drawings and the claims.

### BRIEF DESCRIPTION OF THE DRAWINGS

FIG. 1 is a block diagram of principal components of the full-duplex speakerphone of the present invention.

FIG. 2A illustrates a sample pass-band full audio range (20 Hz-20 KHz) for the broadcast mode of operation, while FIG. 2B illustrates a sample pass-band only voice band (200 Hz-4 KHz) for the full duplex speakerphone mode of operation.

FIG. 3 illustrates one technique for reducing feedback in the present invention.

### DESCRIPTION OF THE PREFERRED EMBODIMENT

### 1. Detailed Description of the Figures

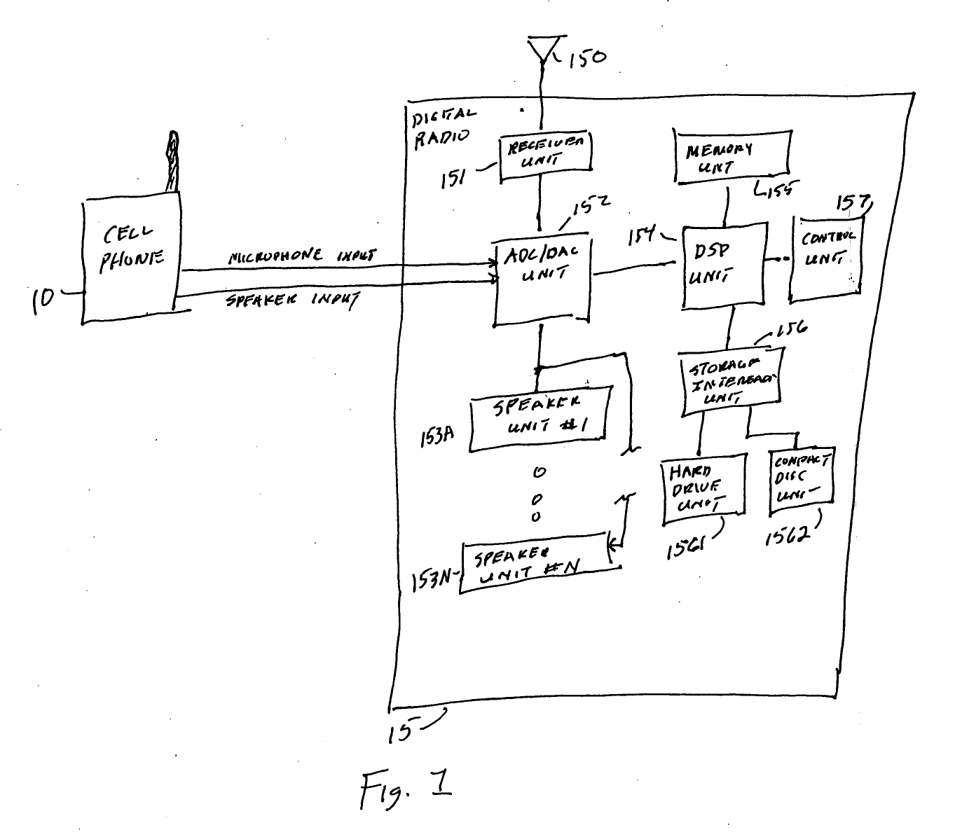

Referring now to FIG. 1, a block diagram of apparatus for implementing the present invention is shown. The present invention contemplates the use of a digital automobile radio along with a cell phone to obtain a full duplex functionality in the automobile. The two main components are a cell phone 10 and a digital radio 15. In one application of the present invention, the digital radio 15 is in an automobile. The cell phone 10 can include a headset microphone so that the hands of the automobile driver are free. The digital radio 15 includes an antenna 150 for receiving an analog broadcast signal. The signal from the antenna 150 is applied to the receiver unit 151 for extracting and demodulating the transmitted signal to remove the carrier signal. The demodulated broadcast signal form receiver 151 is applied to the ADC (analog-to digital converter/DAC (digital-to analog converter) unit 152 for conversion to a digital signal. The digital signal from the ADC/DAC unit 152 is applied to the DSP unit 154 for processing under control of a control panel 157. After processing by the DSP unit 154, the audio signals are returned to the ADC/DAC unit 152 for conversion to an audio signal. The audio signals from the ADC/DAC unit 152 are applied to the speaker system. The DSP unit 154 is supported by memory unit 155 and can have a hard disc unit 1561 and/or a compact disk unit 1562 coupled to the DSP unit 154 through an interface unit 156. Cell phone 10 has the microphone input and the input to the cell phone speakers applied to ADC/DAC unit 152. These analog signals from the cell phone are converted to digital signals, processed by the DSP unit 154, and reconverted to analog signals by the ADC/DAC unit 152. The resulting analog signals are then applied to the speaker units 153A-153N.

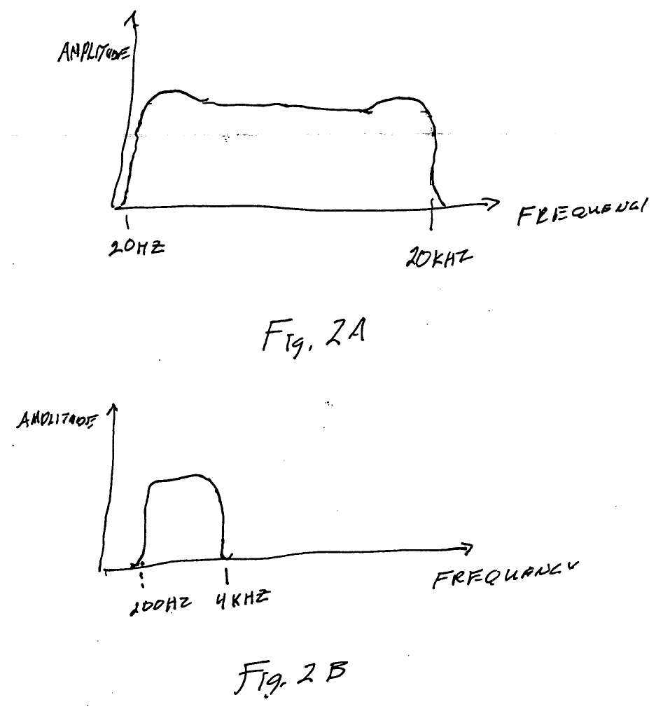

The memory unit 155 and/or the storage units 1561 and 1562 can include software programs that can be invoked to improve the operation of the system. Referring to FIG. 2A and FIG. 2B, the DSP unit can process the signals differently depending on the application. FIG. 2A illustrates a pass-band that is suitable for high fidelity (musical) audio signals. FIG. 2B illustrates a pass-band suitable for voice signals. The use of pass-band shown in FIG. 2B is appropriate for the speakerphone mode of operation, while the pass-band illustrated by FIG. 2A is suitable when the system is being used to play the material received from a broadcast signal.

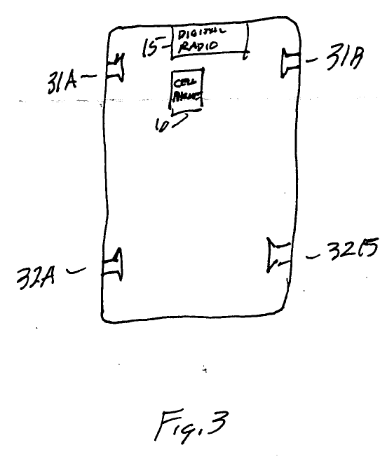

The noise or echo that is present when the speakers can apply audio signals to microphone can be reduced by two techniques. The first technique is to provide the DSP system with an echo-cancellation program that can reduce the effect of the audio feedback. The second technique, illustrated in FIG. 3, uses the fact the modern automobile audio systems have multiple speakers. The cell phone 10 is typically operated by the driver in the front of the car. The speakers 31A and 31B will provide a larger feedback signal than speakers 32A and 32B which are located further from the input microphone. Therefore, echo-cancellation can be obtained if the nearest speakers 31A and 31B are inactivated.

The DSP unit automatically determines which mode is selected and inserts the right algorithms to enhance the audio performance. In broadcast, the DSP unit can provide an audio equalizer to compensate for the acoustic loss in the car and, in speakerphone, DSP limits the audio to voice band to reduce the out of band noise that affects the echo cancellation algorithm.

### 2. Operation of the Preferred Embodiment

The operation of the present invention can be understood as follows. In the broadcast reception mode of operation, the input signals from the cell phone are not processed. Only the broadcast signals are processed and applied to the speakers enhanced audio by running equalizer algorithms. In the full-duplex, speakerphone mode of operation, the broadcast signals are not processed by the digital radio, the microphone and speaker signals from the cell phone are processed and applied to the digital radio speakers. The two modes of operation can have different pass-bands and the speakerphone mode can have an echo-cancellation procedure in processing the audio signals and can inactivate selected speakers to provide additional echo-cancellation. The differences between the two modes of operation can be invoked by the control unit or can automatically invoke when signals are sensed by the ADC/DAC unit from the cell phone. It will be clear that the microphone input for the cell phone can be from a headset, thereby permitting hands-free operation once the cell phone connection has been achieved.

While the present invention has been described with respect to the combination of a cell phone and an automobile digital radio, it will be clear that the digital radio need not be associated with an automobile to practice the invention.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A full-duplex speakerphone system for use in an automobile, the system comprising:
a cell phone; and
a digital radio coupled to the cell phone, the system having two modes of operation, broadcast signals being applied to the speakers of digital radio in the first mode of operation, cell phone microphone and cell phone speaker signals being applied to the digital radio speakers in the second mode of operation.

2. The system as recited in claim 1 wherein the second mode of operation is a full-duplex mode of operation.

3. The system as recited in claim 2 wherein the first mode of operation has a first band-pass and the second mode of operation has a second band-pass, the system dynamically switches between two modes depending on the mode selected by the user.

4. The system as recited in claim 1 wherein the digital radio is an automobile digital radio.

5. The system as recited in claim 1 wherein the digital radio includes:
an ADC/DAC unit for converting incoming analog signals to digital signals; and
a processor unit processing digital signals according to preselected procedures, wherein the processed signals from the processor are converted to analog signals in the ADC/DAC unit.

6. The method of providing a full-duplex speakerphone operation, the method comprising:
applying cell phone microphone and cell phone speaker signals to a digital radio;
processing the microphone and speaker signals in the digital radio; and
applying the processed signals to digital radio speakers.

7. The method as recited in claim 6 further including implementing the digital radio with an automobile digital radio.

8. The method as recited in claim 6 wherein the processing step includes an echo-cancellation procedure.

9. The method as recited in claim 6 further including the step when the microphone and speaker signals are not applied to the digital radio, applying broadcast signals to the digital radio.

10. A digital radio having an ADC/DAC unit, a processing unit, and a speaker system, the radio comprising;
a first connector for coupling cell phone microphone signals to the ADC/DAC unit; and
a second connector for coupling cell phone speaker signals to the ADC/DAC unit;
wherein when the ADC/DAC unit receives cell phone signals, broadcast signals are prevented from being applied to the ADC/DAC unit.

11. The digital radio as recited in claim 10 wherein the digital radio is an automobile digital radio.

12. The digital radio as recited in claim 11 wherein the digital radio provides a full-duplex speakerphone for the cell phone.

13. The digital radio as recited in claim 10 wherein the processing unit automatically shuts down the speakers closest to the microphone to reduce acoustic feedback that degrades the performance of the echo canceller.
